(19) United States
(12) Patent Application Publication
(10) Pub. No.: US 2013/0326195 A1
(43) Pub. Date: Dec. 5, 2013

(54) PREVENTING EXECUTION OF PARITY-ERROR-INDUCED UNPREDICTABLE INSTRUCTIONS, AND RELATED PROCESSOR SYSTEMS, METHODS, AND COMPUTER-READABLE MEDIA

(71) Applicant: QUALCOMM INCORPORATED, San Diego, CA (US)

(72) Inventors: Michael Scott McIlvaine, Raleigh, NC (US); James Norris Dieffenderfer, Apex, NC (US); Brian Michael Stempel, Raleigh, NC (US); Leslie Mark DeBruyne, Cary, NC (US); Melinda J. Brown, Raleigh, NC (US)

(73) Assignee: QUALCOMM INCORPORATED, San Diego, CA (US)

(21) Appl. No.: 13/787,907

(22) Filed: Mar. 7, 2013

Related U.S. Application Data
(60) Provisional application No. 61/655,147, filed on Jun. 4, 2012.

(51) Int. Cl. G06F 9/30

(52) U.S. Cl. CPC G06F 9/30196
USPC 712/208

(57) ABSTRACT

Preventing execution of parity-error-induced unpredictable instructions, and related processor systems, methods, and computer-readable media are disclosed. In this regard, a method for processing instructions in a central processing unit (CPU) is provided. The method comprises decoding an instruction comprising a plurality of bits, and generating a parity error indicator indicating whether a parity error exists in the plurality of bits prior to execution of the instruction. If the parity error indicator indicates that the parity error exists in the plurality of bits, one or more of the plurality of bits are modified to indicate a no execution operation (NOP), without effecting a roll back of a program counter of the CPU and without re-decoding the instruction. In this manner, the possibility of the parity error causing an inadvertent execution of an unpredictable instruction is reduced.

### PRIORITY CLAIM

The present application claim priority to U.S. Provisional Patent Application Ser. No. 61/655,147 filed on Jun. 4, 2012, and entitled “PREVENTING EXECUTION OF PARITY-ERROR-INDUCED UNPREDICTABLE INSTRUCTIONS IN INSTRUCTION PROCESSING CIRCUITS, AND RELATED PROCESSOR SYSTEMS AND METHODS,” which is incorporated herein by references in its entirety.

### BACKGROUND

I. Field of the Disclosure

The technology of the disclosure relates to processing of computer instructions in central processing unit (CPU)-based systems.

II Background

The universe of instructions that can be executed by a central processing unit (CPU) of a computer is defined by an “instruction set architecture,” such as the ARM architecture. The instruction set architecture specifies the semantics of all legal encodings of instructions and arguments in the instruction set. By applying the specifications provided by the instruction set architecture, the validity or invalidity of a given instruction encoding may be readily determined.

However, some instruction set architectures designate certain instruction encodings as “unpredictable.” Such instruction encodings are technically valid, in that they comply with the semantics of the instruction set, but nevertheless the instruction encodings are architecturally incorrect. As a result, the instruction set architecture is unable to specify the outcome that will occur should execution of the unpredictable instruction encodings be attempted. Execution of unpredictable instruction encodings is undesirable because of the risk of causing a system hang, or a violation of user privileges or system security. Moreover, additional logic may need to be implemented in hardware to handle the special cases raised by unpredictable instruction encodings.

Some implementations of instruction set architectures attempt to reduce the risks posed by unpredictable instruction encodings by checking for unpredictable conditions prior to placing the instructions in an instruction cache (“I-cache”). If a problematic unpredictable instruction encoding is detected, a modified or replaced instruction can be placed in the I-cache in lieu of the original instruction. However, the bits of an instruction already stored in the I-cache may be altered by a parity error, resulting in an unpredictable instruction encoding in the I-cache. This may result in the unpredictable instruction encoding being executed and potentially causing a system hang, a privilege or security violation, or an occurrence of an undesirable special case. Recovering from execution of the unpredictable instruction may also require that a program counter of the CPU be rolled back to a previous state or that the unpredictable instruction be re-decoded, resulting in decreased CPU performance.

### SUMMARY OF THE DISCLOSURE

Embodiments disclosed in the detailed description include preventing execution of parity-error-induced unpredictable instructions, and related processor systems, methods, and computer-readable media. In this regard, in one embodiment a method for processing instructions in a central processing unit (CPU) is provided. The method comprises decoding an instruction comprising a plurality of bits in an instruction pipeline of a CPU, and generating a parity error indicator indicating whether a parity error exists in the plurality of bits prior to execution of the instruction. If the parity error indicator indicates that the parity error exists in the plurality of bits, one or more of the plurality of bits are modified to indicate a no execution operation (NOP), without effecting a roll back of a program counter of the CPU and without re-decoding the instruction. In this manner, the possibility of the parity error causing an inadvertent execution of an unpredictable instruction is reduced, without incurring a CPU performance penalty associated with rolling back the program counter or re-decoding the instruction.

In another embodiment, an instruction processing circuit in a CPU is provided. The instruction processing circuit comprises an instruction decoding circuit, a parity error detection circuit, and an instruction modification circuit. The instruction decoding circuit is configured to decode an instruction comprising a plurality of bits. The parity error detection circuit is configured to generate a parity error indicator indicating whether a parity error exists in the plurality of bits prior to execution of the instruction. The instruction modification circuit is configured to receive as input the parity error indicator. The instruction modification circuit is further configured to modify one or more of the plurality of bits to indicate a NOP if the parity error indicator indicates that the parity error exists in the plurality of bits, without effecting a roll back of a program counter of the CPU and without re-decoding the instruction,

in another embodiment, an instruction processing circuit is provided. The instruction processing circuit comprises a means for decoding an instruction comprising a plurality of bits. The instruction processing circuit further comprises a means for generating a parity error indicator indicating whether a parity error exists in the plurality of bits prior to execution of the instruction. The instruction processing circuit also comprises a means for modifying one or more of the plurality of bits to indicate a NOP if the parity error indicator indicates that the parity error exists in the plurality of bits, without effecting a roll back of a program counter of the CPU and without re-decoding the instruction.

In another embodiment, a non-transitory computer-readable medium is provided, having stored thereon computer-executable instructions to cause a processor to implement a method comprising decoding an instruction comprising a plurality of bits. The method implemented by the computer-executable instructions further comprises generating a parity error indicator indicating whether a parity error exists in the plurality of bits prior to execution of the instruction. The method implemented by the computer-executable instructions also comprises modifying one or more of the plurality of bits to indicate a NOP if the parity error indicator indicates that the parity error exists in the plurality of bits, without effecting a roll back of a program counter of the CPU and without re-decoding the instruction.

### BRIEF DESCRIPTION OF THE FIGURES

FIG. 1 is a block diagram of an exemplary processor that includes an instruction processing circuit configured to prevent execution of parity-error-induced unpredictable instructions;

FIG. 2 is a diagram illustrating processing of a parity-error-induced unpredictable instruction by the instruction processing circuit of FIG. 1;

FIG. 3 is a flowchart showing exemplary operations for detecting parity errors in decoded instructions, and preventing execution of instructions in which parity errors are detected;

FIG. 4 is a diagram illustrating the effect of processing by the instruction processing circuit of FIG. 1 on an exemplary instruction stream in which a parity error has given rise to an unpredictable instruction; and

FIG. 5 is a block diagram of an exemplary processor-based system that can include the instruction processing circuit of FIG. 1.

### DETAILED DESCRIPTION

With reference now to the drawing figures, several exemplary embodiments of the present disclosure are described. The word “exemplary” is used herein to mean “serving as an example, instance, or illustration.” Any embodiment described herein as “exemplary” is not necessarily to be construed as preferred or advantageous over other embodiments.

Embodiments disclosed in the detailed description include preventing execution of parity-error-induced unpredictable instructions, and related processor systems, methods, and computer-readable media. In this regard, in one embodiment a method for processing instructions in a central processing unit (CRU) is provided. The method comprises decoding an instruction comprising a plurality of bits in an instruction pipeline of a CPU, and generating a parity error indicator indicating whether a parity error exists in the plurality of bits prior to execution of the instruction. If the parity error indicator indicates that the parity error exists in the plurality of bits, one or more of the plurality of bits are modified to indicate a no execution operation (NOP), without effecting a roll back of a program counter of the CPU and without re-decoding the instruction. In this manner, the possibility of the parity error causing an inadvertent execution of an unpredictable instruction is reduced, without incurring a CPU performance penalty associated with rolling back the program counter or re-decoding the instruction.

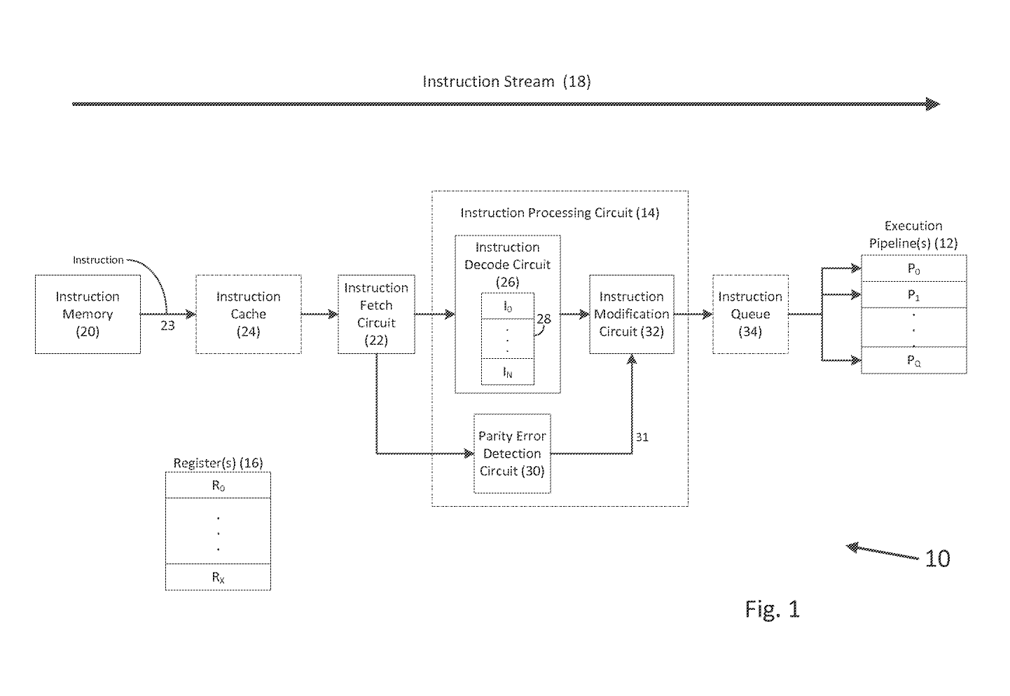

In this regard, FIG. 1 is a block diagram of an exemplary processor-based system 10 for retrieving and processing computer instructions to be placed into one or more execution pipelines 12(0-Q). The processor-based system 10 includes an instruction processing circuit 14 configured to prevent execution of parity-error-induced unpredictable instructions without effecting a roll back of a program counter of a CPU and without re-decoding the instruction. As discussed herein, “instructions” may refer to a combination of bits defined by an instruction set architecture that directs a computer processor to carry out a specified task or tasks. Exemplary instruction set architectures include, but are not limited to, ARM, Thumb, and A64 architectures. An instruction set architecture specifies the semantics of all legal encodings of instructions and arguments in the instruction set. Some instruction encodings may be considered “unpredictable,” in that they are semantically legal according to the instruction set architecture, but the outcome of executing the instruction cannot be specified by the instruction set architecture. The instructions processed by the instruction processing circuit 14 may indicate operations for reading data from and/or writing data to registers 16(0-X) (referred to herein as R₀-Rₓ, respectively), which provide local high-speed storage accessible by the processor-based system 10.

With continuing reference to FIG. 1, the instructions are processed in the processor-based system 10 in a continuous flow represented by an instruction stream 18. The instruction stream 18 may be continuously processed while the processor-based system 10 is operating. in this illustrated example, the instruction stream 18 begins with an instruction memory 20, which provides persistent storage for the instructions in a computer-executable program. An instruction fetch circuit 22 reads an instruction represented by arrow 23 (hereinafter “instruction 23”) from the instruction memory 20 and/or optionally from an instruction cache 24, and may increment a program counter, which may be stored in one of the registers 16(0-X).

The instruction processing circuit 14 of the processor-based system 10 may comprise an instruction decode circuit 26 holding a group of multiple instructions 28(0-N) simultaneously for decoding, as well as a parity error detection circuit 30, and an instruction modification circuit 32. The instruction decode circuit 26 receives the instruction 23 from the instruction fetch circuit 22, and decodes the instruction 23 by translating it into processor-specific microinstructions. The parity error detection circuit 30 also receives the instruction 23 from the instruction fetch circuit 22. The parity error detection circuit 30 generates a parity emir indicator represented by arrow 31 that indicates whether a parity error exists in a plurality of bits (not shown) constituting the instruction 23.

The instruction decode circuit 26 and the parity error detection circuit 30 then provide the instruction 23 and the parity error indicator 31, respectively, to an instruction modification circuit 32. The instruction modification circuit 32 is configured to modify one or more of the plurality of bits constituting the instruction 23 to indicate a NOP if the parity error indicator 31 indicates that the parity error exists in the plurality of bits. In some embodiments, modifying the one or more of the plurality of bits by the instruction modification circuit 32 to indicate a NOP may comprise modifying an encoding of the instruction 23. Some embodiments may provide that modifying the one or more of the plurality of bits by the instruction modification circuit 32 to indicate a NOP may comprise de-asserting a control signal associated with the instruction 23, where the control signal would have otherwise caused the instruction 23 to perform an action. In some embodiments, modifying the one or more of the plurality of bits by the instruction modification circuit 32 to indicate a NOP may comprise preventing the instruction 23 from reading and/or writing one or more architected resources, one or more non-architected resources, or a combination thereof. As used herein and understood by one of skill in the art, “architected resources” are processing resources provided by the CPU architecture, such as the registers 16(0-X) of FIG. 1, that may be utilized by programs being executed by the CPU. In contrast, “non-architected resources” are processing resources provided to assist the CPU, such as scratch registers, buffers, stacks, and the like.

The instruction 23 may then optionally be issued to an instruction queue 34 (i.e., a buffer for storing instructions), or the instruction 23 may be issued to one of the execution pipelines 12(0-Q) for execution. in some embodiments, particular execution pipelines 12(0-Q) may restrict the types of operations that may be carried out within that particular execution pipeline. For example, pipeline P₀ may not permit read access to the registers 16(0-X); accordingly, an instruction that indicates an operation to read register R₀ may only be issued to one of the execution pipelines P₁ through P_{Q}.

With continuing reference to FIG. 1, the instruction processing circuit 14 is configured to determine whether a parity error exists in the instruction 23 fetched from the instruction cache 24, and if the parity error is detected, to modify the instruction 23 to indicate a NOP. The instruction processing circuit 14 may be any type of device or circuit, and may be implemented or performed with a processor, a Digital Signal Processor (DSP), an Application Specific Integrated Circuit (ASIC), a Field-Programmable Gate Array (FPGA) or other programmable logic device, discrete gate or transistor logic, discrete hardware components, or any combination thereof designed to perform the functions described herein.

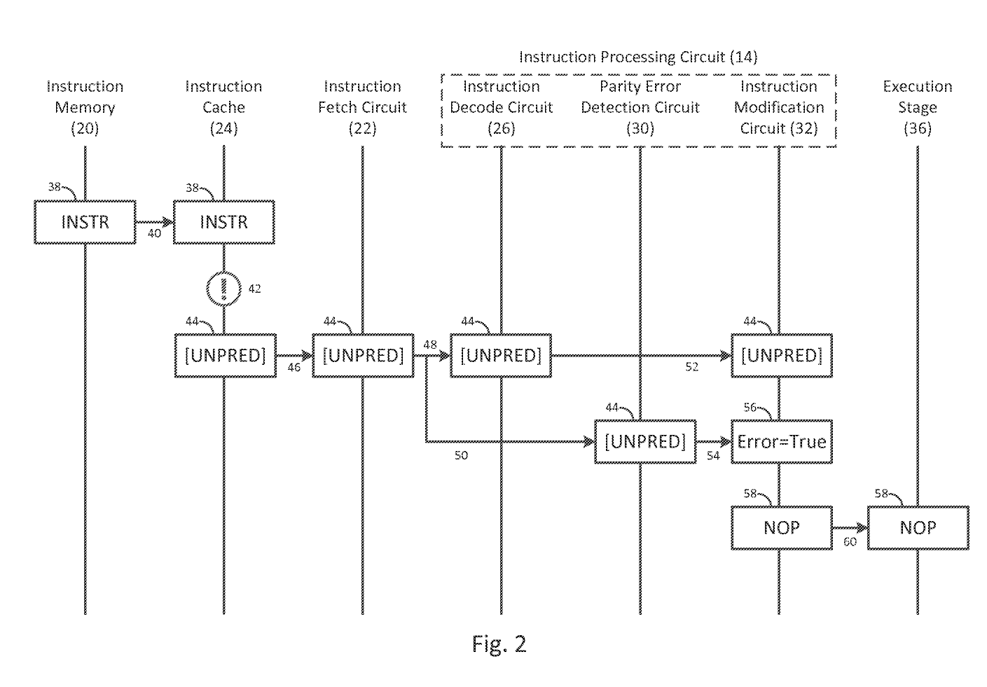

To more clearly illustrate an exemplary processing of a parity-error-induced unpredictable instruction by the instruction processing circuit 14 of FIG. 1, FIG. 2 is provided with additional reference to FIG. 1. FIG. 2 is a diagram showing the progression of an instruction through the processor-based system 10 of FIG. 1, including an occurrence of a parity error resulting in an unpredictable instruction, a subsequent detection of the parity error, and a modification of the instruction to indicate a NOP. In this example, the processor-based system 10 is represented by a series of vertical lines corresponding to the instruction memory 20, the instruction cache 24, the instruction fetch circuit 22, the instruction decode circuit 26, the parity error detection circuit 30, the instruction modification circuit 32, and an execution stage 36. As noted above and shown in FIG. 2, the instruction processing circuit 14 comprises the instruction decode circuit 26, the parity error detection circuit 30, and the instruction modification circuit 32. The execution stage 36 represents one or more execution pipeline stages in which the instruction is queued in the optional instruction queue 34 or issued to one of the execution pipelines 12(0-Q) for execution.

As seen in FIG. 2, the instruction memory 20 stores an exemplary instruction (INSTR) 38. The instruction 38 may represent any legal instruction encoding provided by an instruction set architecture, where the result of executing the instruction is specified by the instruction set architecture (i.e., the instruction is not unpredictable). The instruction 38 is retrieved from the instruction memory 20, as indicated by arrow 40, and stored in the instruction cache 24. While residing in the instruction cache 24, one or more bits of the instruction 38 are altered by an error-inducing event 42. For example, electrons in a hardware component of the instruction cache 24 may be disturbed by alpha particles emitted by radioactive contaminants in the hardware component, or by cosmic rays striking the hardware component. As a result of the error-inducing event 42, the instruction 38 is changed into an unpredictable instruction [UNPRED] 44. The unpredictable instruction 44 may represent an architecturally incorrect instruction encoding for which the outcome of execution cannot be specified by the instruction set architecture.

As indicated by arrow 46 of FIG. 2, the unpredictable instruction 44 is fetched from the instruction cache 24 by the instruction fetch circuit 22. The instruction fetch circuit 22 then provides the unpredictable instruction 44 to both the instruction decode circuit 26 (as indicated by arrow 48), and to the parity error detection circuit 30 (as indicated by arrow 50). The instruction decode circuit 26 decodes the unpredictable instruction 44 and provides a decoded instruction to the instruction modification circuit 32, as shown by arrow 52. The parity error detection circuit 30 evaluates the bits of the unpredictable instruction 44, and determines that a parity error has occurred. Accordingly, as shown by arrow 54, the parity error detection circuit 30 generates a parity error indicator (Errol=True) 56 indicating that the unpredictable instruction 44 contains a parity error, and provides the parity error indicator 56 to the instruction modification circuit 32.

With continuing reference to FIG. 2, the instruction modification circuit 32 then receives the parity error indicator 56 generated by the parity error detection circuit 30 indicating that the unpredictable instruction 44 contains a parity error. As a result, the instruction modification circuit 32 modifies one or more of the bits of the unpredictable instruction 44 to indicate a NOP instruction 58. As discussed, modifying one or more of the bits of the unpredictable instruction 44 may include modifying an encoding of the instruction, by de-asserting a control signal associated with the instruction, and/or by preventing the instruction from reading or writing one or more architected resources, one or more non-architected resources, or a combination thereof. The instruction modification circuit 32 then forwards the NOP instruction 58 to the execution stage 36, as indicated by arrow 60, for queuing and/or execution. In this manner, execution of the unpredictable instruction 44 is prevented without incurring a CPU performance penalty associated with rolling back a program counter of the CPU or re-decoding the unpredictable instruction 44.

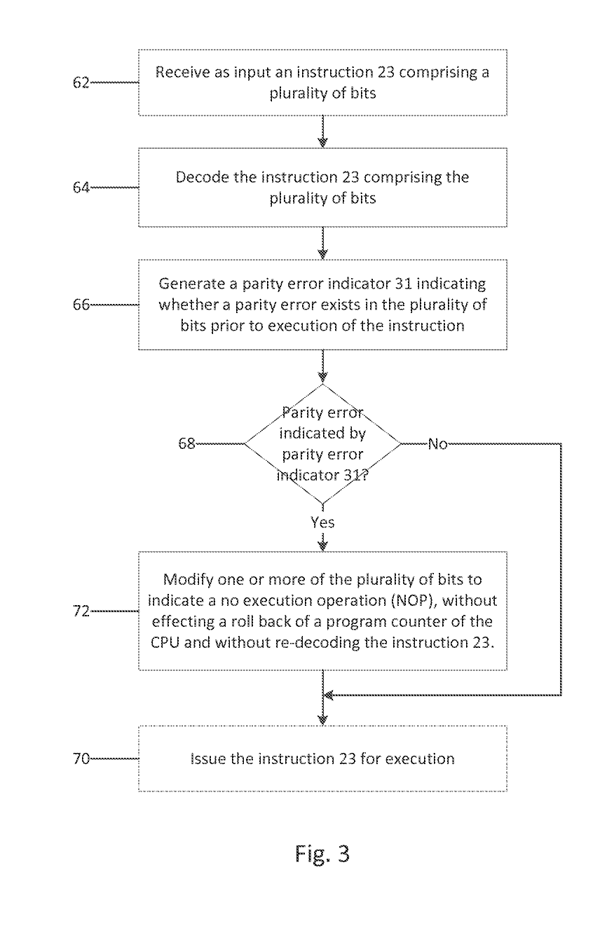

FIG. 3 is a flowchart showing exemplary operations of the instruction processing circuit 14 in FIGS. 1 and 2 for detecting parity errors in decoded instructions, and preventing execution of instructions in which parity errors are detected. The operations begin with the instruction processing circuit 14 receiving as input the instruction 23 comprising a plurality of bits (block 62). In some embodiments, the instruction 23 is received by the instruction processing circuit 14 from an instruction cache, such as the instruction cache 24 of FIG. 1. The instruction processing circuit 14 then decodes the instruction 23 comprising the plurality of bits (block 64). Some embodiments may provide that decoding the instruction 23 may be carried out by an instruction decode circuit of the instruction processing circuit 14, such as the instruction decode circuit 26 of FIG. 1.

A parity error indicator 31, indicating whether a parity error exists in the plurality of bits prior to execution of the instruction 23, is generated by the instruction processing circuit 14 (block 66). In some embodiments, the parity error indicator 31 may be generated by a parity error detection circuit, such as the parity error detection circuit 30 of FIG. 1. The instruction processing circuit 14 then evaluates whether the parity error indicator 31 indicates that a parity error exists in the plurality of bits of the instruction 23 (block 68). If no parity error is indicated by the parity error indicator 31, the instruction 23 may be issued for execution (block 70). If a parity error is detected in the plurality of bits of the instruction 23, the instruction processing circuit 14 modifies one or more of the plurality of bits to indicate a no execution operation (NOP) (block 72). Some embodiments may provide that modifying one or more of the plurality of bits includes modifying an encoding of the instruction 23, de-asserting a control signal associated with the instruction 23, and/or preventing the instruction 23 from reading or writing one or more architected resources, one or more non-architected resources, or a combination thereof. After the one or more of the plurality of bits is modified, the instruction 23 may be issued for execution (block 70). The modification of the one or more of the plurality of bits by the instruction processing circuit 14 is made without effecting a roll back of a program counter of the CPU, and without re-decoding the instruction 23. In this manner, both the undesirable consequences of executing an unpredictable instruction and the CPU performance penalty associated with rolling back the program counter or re-decoding the instruction may be avoided.

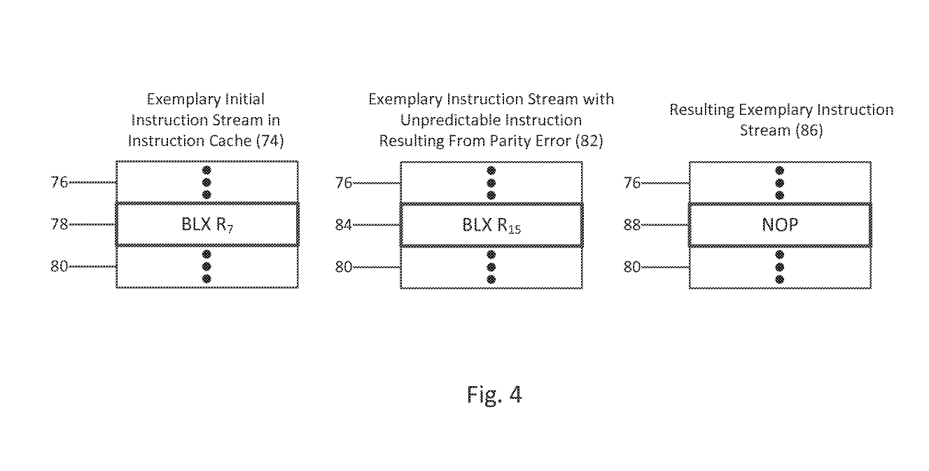

FIG. 4 is provided to better illustrate the effect of processing by the instruction processing circuit 14 of FIGS. 1 and 2 on an exemplary instruction stream in which a parity error has given rise to an unpredictable instruction. In FIG. 4, an exemplary initial instruction stream 74 is shown as stored in an instruction cache, such as the instruction cache 24 of FIGS. 1 and 2. In this example, the initial instruction stream 74 comprises a series of ARM architecture instructions. First in the initial instruction stream 74 is a series of preceding instructions 76. Next in the initial instruction stream 74 is a BLX. (“branch with link”) instruction 78, which is then followed by a series of subsequent instructions 80. The effect of executing the BLX instruction 78 in the initial instruction stream 74 would be to store an address of a next instruction in the series of subsequent instructions 80 in a link register, and then transfer program control to an instruction address stored in one of the registers 16(0-X) (here, register R₇).

With continuing reference to FIG. 4, an exemplary instruction stream 82 illustrates how the occurrence of a parity error may lead to an unpredictable instruction in the instruction cache. Here, the series of previous instructions 76 and the series of subsequent instructions 80 remain unchanged, but a parity error has flipped a bit in the instruction cache, modifying a portion of the BLX instruction 78 identifying the register R₇ to identify register R₁₅ instead. The result of the parity error is a BLX instruction 84 in the instruction stream 82. The BLX instruction 84 operates very similarly to the BLX instruction 78, except that, in the ARM instruction set architecture, execution of the BLX instruction 84 is unpredictable. This could potentially cause a system hang, a privilege or security violation, or an occurrence of an undesirable special case.

Accordingly, to prevent execution of the parity-error-induced unpredictable instruction, the instruction processing circuit 14 modifies one or more of the plurality of bits of the BLX instruction 84 to indicate a NOP. This is shown in resulting instruction stream 86 of FIG. 4. As seen therein, the series of previous instructions 76 and the series of subsequent instructions 80 are still unchanged, but the BLX instruction 84 has been replaced in the resulting instruction stream 86 with an NOP instruction 88. By replacing the BLX instruction 84 with the NOP instruction 88, both the undesirable consequences of executing an unpredictable instruction and the CPU performance penalty associated with rolling back the program counter or re-decoding the instruction may be avoided. Note that while replacing the BLX instruction 84 with the NOP instruction 88 avoids execution of an unpredictable instruction, the resulting instruction stream 86 remains a deviation from the initial instruction stream 74, and may require additional processing and/or error handling by the executing program in order to recover.

Preventing execution of parity-error-induced unpredictable instructions, and related processor systems, methods, and computer-readable media according to embodiments disclosed herein may be provided in or integrated into any processor-based device. Examples, without limitation, include a set top box, an entertainment unit, a navigation device, a communications device, a fixed location data unit, a mobile location data unit, a mobile phone, a cellular phone, a computer, a portable computer, a desktop computer, a personal digital assistant (PDA a monitor, a computer monitor, a vision, a tuner, a radio, a satellite radio, a music player, a digital music player, a portable music player, a digital video player, a video player, a digital video disc (DVD) player, and a portable digital video player.

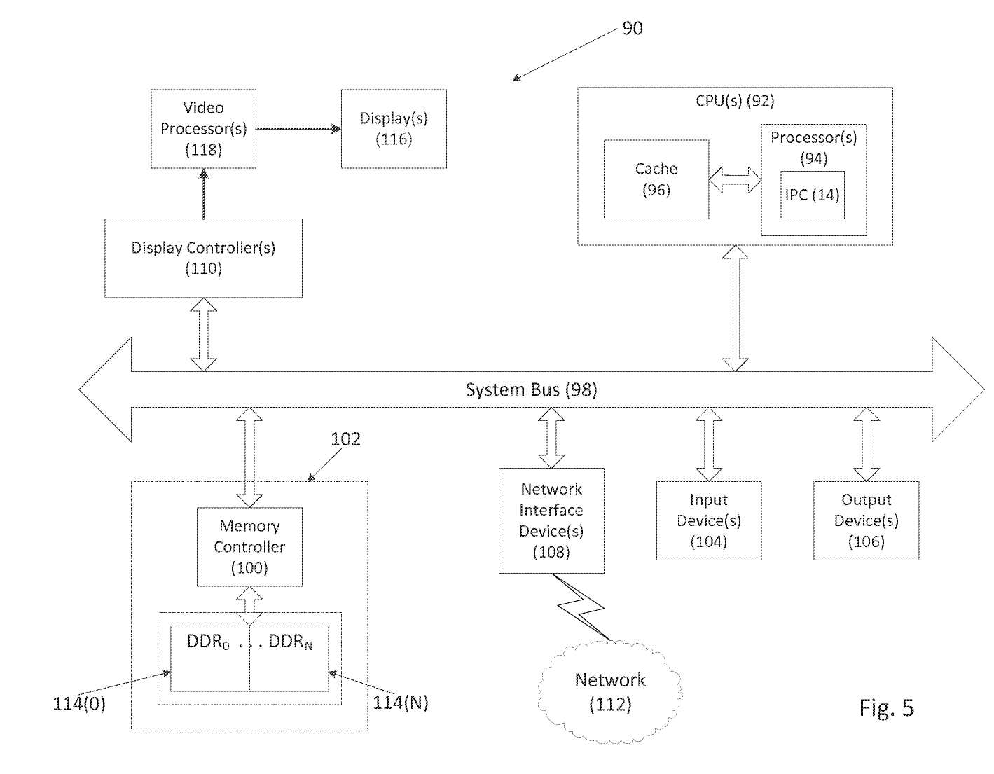

In this regard, FIG. 5 illustrates an example of a processor-based system 90 that can employ the instruction processing circuit 14 illustrated in FIG. 1. In this example, the processor-based system 90 includes one or more central processing units (CPUs) 92, each including one or more processors 94. The one or more processors 94 may comprise the instruction processing circuit (IPC) 14. The CPU(s) 92 may have cache memory 96 coupled to the processor(s) 94 for rapid access to temporarily stored data. The CPU(s) 92 is coupled to a system bus 98 and can intercouple master and slave devices included in the processor-based system 90. As is well known, the CPU(s) 92 communicates with these other devices by exchanging address, control, and data information over the system bus 98. For example, the CPU(s) 92 can communicate bus transaction requests to a memory controller 100 as an example of a slave device, Although not illustrated in FIG. 5, multiple system buses 98 could be provided.

Other master and slave devices can be connected to the system bus 98. As illustrated in FIG. 5, these devices can include a memory system 102, one or more input devices 104, one or more output devices 106, one or more network interface devices 108, and one or more display controllers 110, as examples. The input device(s) 104 can include any type of input device, including but not limited to input keys, switches, voice processors, etc, The output device(s) 106 can include any type of output device, including but not limited to audio, video. other visual indicators, etc. The network interface device(s) 108 can be any devices configured to allow exchange of data to and from a network 112, The network 112 can be any type of network, including but not limited to a wired or wireless network, a private or public network, a local area network (LAN), a wide local area network (WLAN), and the Internet. The network interface device(s) 108 can be configured to support any type of communication protocol desired. The memory system 102 can include one or more memory units 114(0-N).

The CPU(s) 92 may also be configured to access the display controller(s) 110 over the system bus 98 to control information sent to one or more displays 116. The display controller(s) 110 sends information to the display(s) 116 to be displayed via one or more video processors 118, which process the information to be displayed into a format suitable for the display(s) 116. The display(s) 116 can include any type of display, including but not limited to a cathode ray tube (CRT), a liquid crystal display (LCD), a plasma display, etc.

Those of skill in the art will further appreciate that the various illustrative logical blocks, modules, circuits, and algorithms described in connection with the embodiments disclosed herein may be implemented as electronic hardware, instructions stored in memory or in another computer-readable medium and executed by a processor or other processing device, or combinations of both. The arbiters, master devices, and slave devices described herein may be employed in any circuit, hardware component, integrated circuit (IC), or IC chip, as examples. Memory disclosed herein may be any type and size of memory and may be configured to store any type of information desired. To clearly illustrate this interchangeability, various illustrative components, blocks, modules, circuits, and steps have been described above generally in terms of their functionality. How such functionality is implemented depends upon the particular application, design choices, and/or design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the embodiments disclosed herein may be implemented or performed with a processor, a DSP, an Application Specific Integrated Circuit (ASIC), FPGA other programmable logic device, discrete gate or transistor logic, discrete hardware components, or any combination thereof designed to perform the functions described herein. A processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The embodiments disclosed herein may be embodied in hardware and in instructions that are stored in hardware, and may reside, for example, in Random Access Memory (RAM), flash memory, Read Only Memory (ROM), Electrically Programmable ROM (EPROM), Electrically Erasable Programmable ROM (EEPROM), registers, a hard disk, a removable disk, a CD-ROM, or any other form of computer readable medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

It is also noted that the operational steps described in any of the exemplary embodiments herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary embodiments may be combined. It is to be understood that the operational steps illustrated in the flow chart diagrams may be subject to numerous different modifications as will be readily apparent to one of skill in the art. Those of skill in the art will also understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein, but is to be accorded the widest scope consistent with the principles and novel features disclosed herein.

What is claimed is:

1. A method for processing instructions in a central processing unit (CPU), the method comprising:
decoding an instruction comprising a plurality of bits;
generating a parity error indicator indicating whether a parity error exists in plurality of bits prior to execution of the instruction; and
modifying one or more of the plurality of bits to indicate a no execution operation (NOP) if the parity error indicator indicates that the parity error exists in the plurality of hits, without effecting a roll back of a program counter of a CPU and without re-decoding the instruction.

2. The method of claim 1, further comprising:
prior to decoding the instruction, receiving as input the plurality of bits from an instruction cache.

3. The method of claim 1, wherein modifying the one or more of the plurality of bits to indicate the NOP comprises modifying an encoding of the instruction.

4. The method of claim I, wherein modifying the one or more of the plurality of bits to indicate the NOP comprises preventing the instruction from reading one or more architected resources, one or more non-architected resources, or a combination thereof.

5. The method of claim 1, wherein modifying the one or more of the plurality of bits to indicate the NOP comprises preventing the instruction from writing one or more architected resources, one or more non-architected resources, or a combination thereof.

6. The method of claim 1, wherein modifying the one or more of the plurality of bits to indicate the NOP comprises de-asserting a control signal associated with the instruction.

7. An instruction processing circuit in a central processing unit (CPU), the instruction processing circuit comprising:
an instruction decoding circuit configured to decode an instruction comprising a plurality of bits;
a parity error detection circuit configured to generate a parity error indicator indicating whether a parity error exists in the plurality of bits prior to execution of the instruction; and
an instruction modification circuit configured to:
receive as input the parity error indicator; and
modify one or more of the plurality of bits to indicate a no execution operation (NOP) if the parity error indicator indicates that the parity error exists in the plurality of bits, without effecting a roll back of a program counter of a CPU and without re-decoding the instruction.

8. The instruction processing circuit of claim 7, comprising the instruction decoding circuit further configured to:
prior to decoding the instruction, receive as input the plurality of bits from an instruction cache.

9. The instruction processing circuit of claim 7, comprising the instruction modification circuit configured to modify the one or more of the plurality of bits to indicate the NOP by modifying an encoding of the instruction.

10. The instruction processing circuit of claim 7, comprising the instruction modification circuit configured to modify the one or more of the plurality of bits to indicate the NOP by preventing the instruction from reading one or more architected resources, one or more non-architected resources, or a combination thereof.

11. The instruction processing circuit of claim 7, comprising the instruction modification circuit configured to modify the one or more of the plurality of bits to indicate the NOP by preventing the instruction from writing one or more architected resources, one or more non-architected resources, or a combination thereof.

12. The instruction processing circuit of claim 7, comprising the instruction modification circuit configured to modify the one or more of the plurality of bits to indicate the NOP by de-asserting a control signal associated with the instruction.

13. The instruction processing circuit of claim 7 integrated into a semiconductor die.

14. The instruction processing circuit of claim 7, further comprising a device into which the instruction processing circuit is integrated, the device selected from the group consisting of: a set top box, an entertainment unit, a navigation device, a communications device, a fixed location data unit, a mobile location data unit, a mobile phone, a cellular phone, a computer, a portable computer, a desktop computer, a personal digital assistant (PDA), a monitor, a computer monitor, a television, a tuner, a radio, a satellite radio, a music player, a digital music player, a portable music player, a digital video player, a video player, a digital video disc (DVD) player, and a portable digital video player.

15. An instruction processing circuit comprising:
a means for decoding an instruction comprising a plurality of bits;
a means for generating a parity error indicator indicating whether a parity error exists in the plurality of bits prior to execution of the instruction; and
a means for modifying one or more of the plurality of bits to indicate a no execution operation (NOP) if the parity error indicator indicates that the parity error exists in the plurality of bits, without effecting a roll back of a program counter of a CPU and without re-decoding the instruction.

16. A non-transitory computer-readable medium, having stored thereon computer-executable instructions to cause a processor to implement a method comprising:
decoding an instruction comprising a plurality of bits;
generating a parity error indicator indicating whether a parity error exists in the plurality of bits prior to execution of the instruction; and
modifying one or more of the plurality of bits to indicate a no execution operation (NOP) if the parity error indicator indicates that the parity error exists in the plurality of bits, without effecting a roll back of a program counter of a CPU and without re-decoding the instruction.

17. The non-transitory computer-readable medium of claim 16, having stored thereon the computer-executable instructions to cause the processor to implement the method further comprising:
prior to decoding the instruction, receiving as input the plurality of bits from an instruction cache.

18. The non-transitory computer-readable medium of claim 16, having stored thereon the computer-executable instructions to cause the processor to implement the method wherein modifying the one or more of the plurality of bits to indicate the NOP comprises modifying an encoding of the instruction.

19. The non-transitory computer-readable medium of claim 16, having stored thereon the computer-executable instructions to cause the processor to implement the method wherein modifying the one or more of the plurality of bits to indicate the NOP comprises preventing the instruction from reading one or more architected resources, one or more non-architected resources, or a combination thereof.

20. The non-transitory computer-readable medium of claim 16, having stored thereon the computer-executable instructions to cause the processor to implement the method wherein modifying the one or more of the plurality of bits to indicate the NOP comprises preventing the instruction from writing one or more architected resources, one or more non-architected resources, or a combination thereof.

21. The non-transitory computer-readable medium of claim 16, having stored thereon the computer-executable instructions to cause the processor to implement the method wherein modifying the one or more of the plurality of bits to indicate the NOP comprises de-asserting a control signal associated with the instruction.
